(19) United States
(12) Patent Application Publication
(10) Pub. No.: US 2013/0012234 A1
(43) Pub. Date: Jan. 10, 2013

(54) Systems and Methods for Position Tracking and Reporting of Objects

(76) Inventors: Steven TUFTY, Portland, OR (US); Michael A. FIGUERAS, Portland, OR (US); Bridget A. GOLDSTEIN, Waikoloa, HI (US); Douglas S. GOLDSTEIN, Waikoloa, HI (US)

(21) Appl. No.: 13/176,747

(22) Filed: Jul. 6, 2011

(51) Int. Cl. H04W 4/02; H04W 24/00; G06F 15/16

(52) U.S. Cl. 455/456.3; 709/203; 455/456.6

(57) ABSTRACT

Geographic location and environmental conditions of a tracking target are reported by a position tracking and reporting (“PTR”) device. Reports are aggregated and stored by a server system, which also provides access to the information for interactive and automatic programmatic use. A mobile phone (smartphone) interface allows system conditions to be examined, and PTR device operating envelope to be modified.

### FIELD

The invention relates to monitoring and tracking objects. More specifically, the invention relates to devices and infrastructure that interoperate to permit monitoring of an object's position and environment, and responding to conditions detected at the object.

### BACKGROUND

Contemporary trends in electronics miniaturization, power efficiency and component pricing have vastly increased the capabilities of devices that can be deployed economically. Indeed, for many data-collection and reporting applications, single-use or disposable devices are even viable options. Nevertheless, the various sensing and communication options are not free, so ironically it is more important than ever to select features and design systems carefully to obtain the greatest benefit from the available technologies, without exceeding the price point that places the application beyond the reach of practical applicability.

Electronic devices have been deployed to track and locate mobile assets such as trucks, shipping containers, rail cars, pallets of goods, and many other objects. The most sophisticated of these may permit tracking to within a few meters, but they are not inexpensive, so they may be most useful for moderate- or high-value assets.

Other devices of similar nature have been developed to track and locate people. These devices are useful for caring for persons who may have difficulty getting around or seeking assistance on their own (for example, children or people with Alzheimer's disease) as well as people who may find themselves under the control of people who do not wish to be tracked, or people who themselves do not wish to be tracked (for example, military personnel and prisoners).

Slightly further afield, tracking devices have been used to locate and monitor animals (both wild and domesticated) for scientific study or simple recovery of lost pets.

Transmitters and transceivers for locating and tracking humans have been worn as bracelets, sewn into clothing, carried in backpacks, and even implanted internally (e.g., behind the ear, U.S. Pat. No. 4,706,689; under the skin, U.S. Pat. No. 5,629,678; or in dentalwork, U.S. Pat. No. 6,239,705).

Many contemporary tracking systems rely on the global position system (“GPS”), a satellite-based navigation system. GPS receivers can calculate their position based on information transmitted by at least three of the approximately thirty GPS satellites in orbit about the earth. The use of GPS for obtaining location information is well-known; what is less apparent is the effective use of the location data to accomplish various goals. Novel methods of collecting, communicating and acting on location data (as well as ancillary sensor information) may be of significant value in this field.

### SUMMARY

A geographic location and condition sensing and reporting system collects information from a target and distributes it for use by interactive and automatic users. A mobile data collection and reporting module operates autonomously, but can also be instructed to alter its collection and reporting in response to commands from remote users.

### BRIEF DESCRIPTION OF DRAWINGS

Embodiments of the invention are illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

FIG. 1 shows essential and desirable features of a position tracking and reporting device that can be used with an embodiment of the invention.

FIG. 2 shows relationships between computers and other devices that interact to perform methods according to an embodiment of the invention.

FIG. 3 outlines a method implemented by a position tracking and reporting device.

FIG. 4 represents a budgeting method the reporting device can use to adjust its reporting rate according to environmental conditions and external triggers.

FIG. 5 outlines operations accomplished by devices and programmable logic cooperating in implementing an embodiment of the invention.

FIGS. 6A and 6B show a sample user interface for examining data collected by an embodiment.

### DETAILED DESCRIPTION

Embodiments of the invention use a Position Tracking and Relaying (“PTR”) device comprising a selection of conventional capabilities as a key part of specific novel methods to accomplish a range of goals. The methods can also be performed with devices containing additional functionality, but the following embodiment descriptions will focus on identifying a minimal set of capabilities (and conversely, on getting the most functionality out of a system built around a particular PTR device).

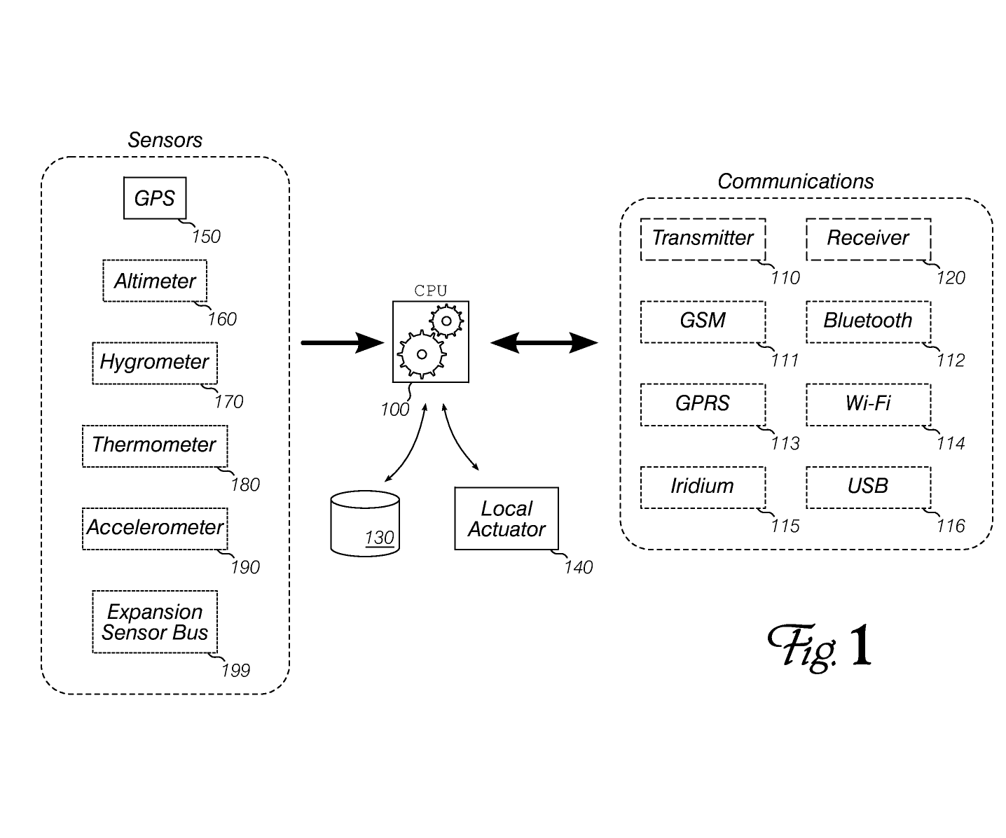

FIG. 1 shows a system block diagram of core components and some optional components of a PTR according to an embodiment of the invention. A PTR has a programmable processor (“CPU”) 100, which operates under the control of instructions stored in a memory (not shown) to perform parts of the methods described below. Many of the other components of the PTR can be grouped together as concerned with either communications or sensing. An embodiment will have at least one of a transmitter function 110 or a receiver function 120. Examples of specific hardware modules that can provide communications include GSM 111 (mobile telephony or “cell phone” functionality); short-range radio Bluetooth 112, General Packet Radio Service (“GPRS”) 113, IEEE 802.11 wireless data links (“Wi-Fi”) 114, Iridium satellite telephony 115, or Universal Serial Bus (“USB,” a wired data link) 116. An embodiment will have a GPS module 150 (or other location-determining device such as LORAN), and may have other sensors such as an altimeter 160, hygrometer 170, thermometer 180 or accelerometer 190. Some embodiments may include an expansion sensor bus 199 so that additional sensors can be added. CPU 100 is provided with a nonvolatile data store 130, which may be a hard disk, solid-state (Flash) memory, or other means for recording information. Finally, an embodiment may have a local actuator 140 to accept input from a person carrying the PTR (e.g., a switch or keypad), or an indicator (e.g., a light or buzzer) to indicate a situation of interest.

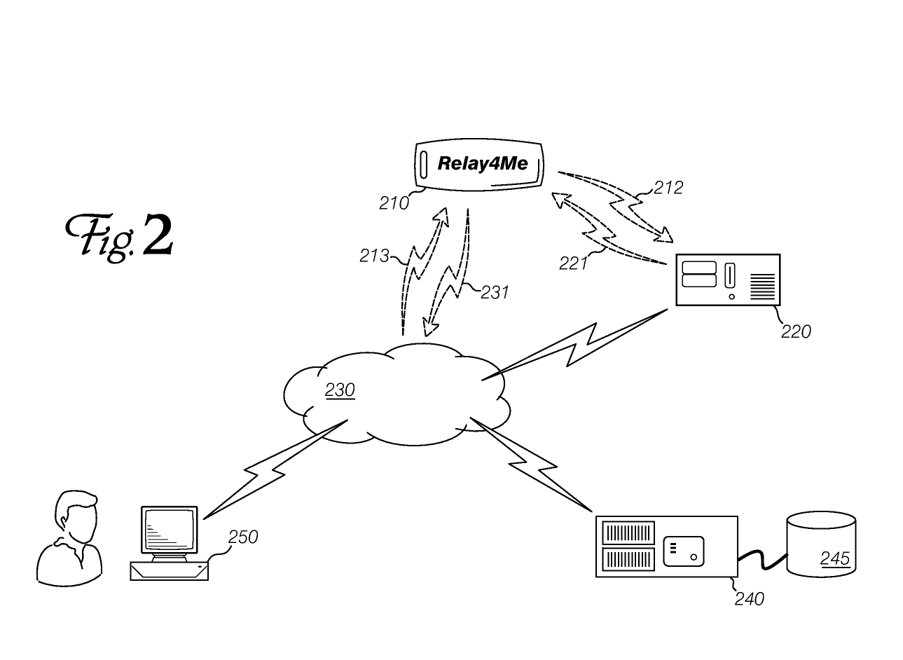

The PTR of FIG. 1 operates within the context of a comprehensive data communication and processing environment similar to the one shown in FIG. 2. There, PTR 210 communicates with other computers 220, 240, 250, either directly over a distributed data network 230 such as the Internet, or indirectly, through a gateway computer 220. As suggested by the dashed, single-direction communication arrows 212, 221, 213, 231, PTR 210 may use different communication channels for various interactions, and may even be unable to either send or receive information (i.e., it may have only a transmitter or only a receiver, as mentioned above). The other computers in this environment, 220, 240 and 250, cooperate in performing the operations described below. It is appreciated that the functions performed by the other computers can be distributed differently than described here. For example, the gateway functions of system 220 could be performed by server 240, as could the user interface functions of client computer 250. However, in many of the exemplary embodiments discussed, it makes sense to allocate the system responsibilities among gateways, servers and client/user-interface machines.

Generally speaking, among the devices shown in FIG. 2, the PTR 210 is responsible for determining the location of the object to be tracked (and any other environmental conditions that it is able to sense). PTR 210, with the possible cooperation of gateway 220, may report its information to other devices, and/or may receive instructions regarding how it should behave based on its location or sensed conditions. Server 240 may receive information from PTR 210 and store it (e.g., in database 245) for later replay or analysis. Client computer 250 may be used to retrieve or view stored information and/or to send instructions to govern the PTR. In many embodiments, server 240 will provide a web-based interface (i.e., a Hypertext Transport Protocol [“HTTP”] server to interact with a Hypertext Markup Language [“HTML”] web-browser client) for client computer 250.

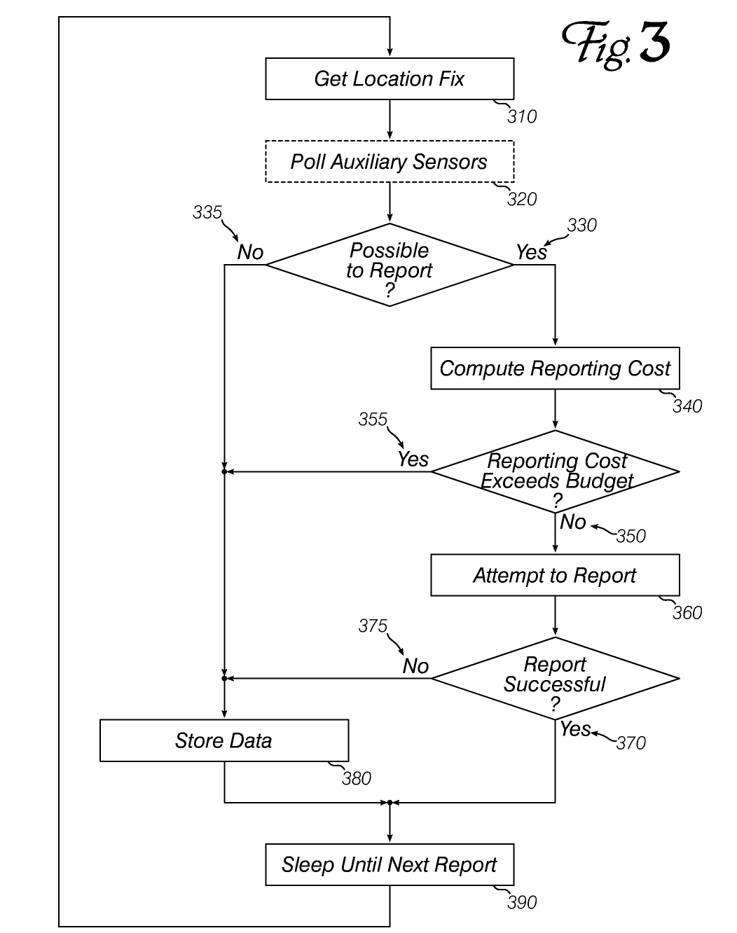

FIG. 3 outlines operations of a logic kernel in a PTR. That is, the PTR's programmable processor performs these operations while the PTR is functioning as part of an embodiment. The operations are repeated periodically at a frequency set by the system operator or determined autonomously by the PTR based on a power, time and cost budget calculation described below.

First, a location fix is obtained from the GPS or other sensor (310). Next, any other sensors in the PTR are queried (320). Now, if it is possible to report (330), the reporting cost is computed (340) and compared to the reporting budget. If the budget is adequate to allow reporting (350), then the PTR attempts to make such a report (360). If it is not possible to report (335) (e.g., because the communication facility is unable to find a signal), or if the reporting cost exceeds the budget (355), or if the reporting attempt failed (375), then the location and optional environment sense data are stored for a future reporting attempt (380). Finally, the device enters an idle or “sleep” mode to conserve power until the next time a fix is to be taken.

The “reporting budget” is a concept used in an embodiment to control circumstances under which the PTR tries to report its location and other information to other parts of the system. A budget is a good way to think about (battery) power utilization, data communication charges and the value to the overall system of an up-to-date position fix from the PTR. For example, consider a PTR that is configured to operate at a basic position/status report rate of once per minute. The budgeting algorithm can adjust the basic rate according to conditions detected during operation. If the energy remaining in the battery is low (i.e., is below a configurable threshold), then a “cost” estimate of making a report can be increased to reduce the report rate and save power. If the PTR has no new information to report (e.g., it has not moved significantly, nor have any environmental conditions changed), then a “value” estimate of the report can be reduced so that it is less likely to exceed the cost estimate (again leading to a reduced report rate).

Other factors can also be incorporated into the value and cost budget. Most directly, some reporting methods may incur a monetary cost. For example, sending a Small Message Service (“SMS”) service via a mobile phone or satellite link may be subject to a data communication charge. If the value of the report does not exceed the cost to make it, then it should be deferred. On the other hand, the PTR can be configured to operate in an “envelope” mode: if its location, speed, altitude, temperature or other conditions are within acceptable bounds, it may consider reports to have a first value. If any of the sensed conditions deviate outside the acceptable bounds, then reports may be assigned a second, higher value. Thus, the system can easily model “urgent” report status—reports that will be made even if the battery capacity is low or the data charges are high. Further, by modeling the reporting budget as a continuous function, where (for example) the value of a report starts at zero immediately after a previous report and increases with time, while the cost of the report starts at an appropriate estimate based on telecommunications cost and battery-capacity state, the report rate can be made flexible and adaptive. Whenever the value of the report exceeds the cost to make the report, the PTR will attempt to send its information.

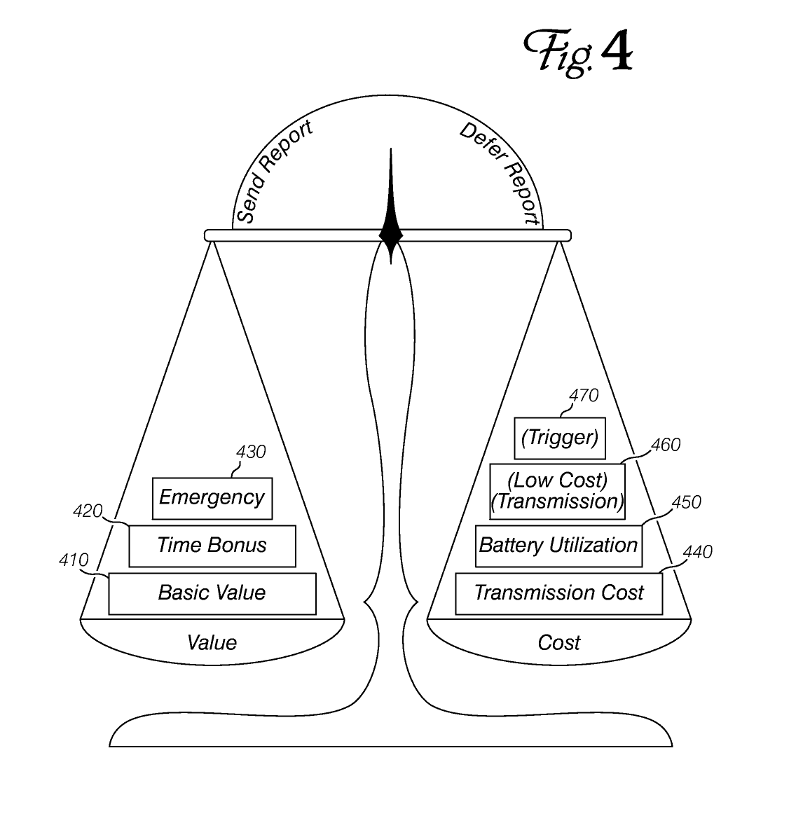

FIG. 4 shows a balance-beam scale representing this budgeting process. In the left balance pan, sample factors affecting the value of a report are shown. The system may assign a fixed basic value to a new report (410), and a variable time-based bonus (420) that increases with the length of time since a previous report. Exigent circumstances (430) may provide an additional value boost. An exigent circumstance may be treated persistently: if the location (or another condition) travels outside a prescribed boundary, subsequent reports may all be considered more valuable (at least until the PTR receives an instruction to the contrary). Alternatively, in other embodiments, if the condition that triggered the exigent circumstance goes away (e.g., the location returns to within the prescribed boundary, or the other condition is rectified), then the exigent-circumstance bonus may be eliminated.

In the right balance pan, items affecting the cost to make a report are counted. As discussed above, the cost may include the monetary cost of transmitting data (440) or the power/battery cost of operating the transmitter device (450). The cost may be subject to a discount, for example, if a lower-cost or lower-power transmission method becomes available (460). (A lower-cost transmission method might be an 802.11 wireless IP connection, or the accumulation of data to be reported that will fill a maximum-sized SMS message.) An external trigger or request to make an immediate report may be accounted as a large discount (470) (or, equivalently, as a large increase in report value). The PTR system software performs budgeting so that a report is attempted when the value of the report exceeds the cost of making it.

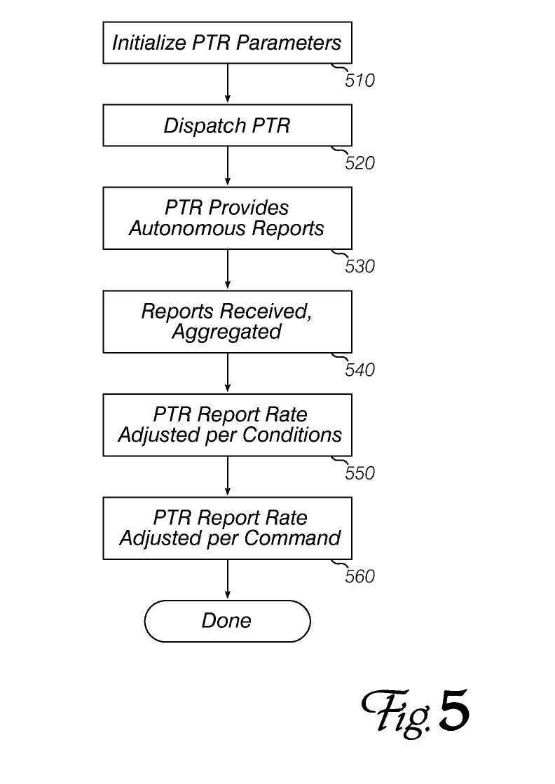

Although the Position Tracking and Reporting device described in FIGS. 1 and 3 operates autonomously at least part of the time, an embodiment of the invention comprises additional functional components as outlined in FIG. 2. Turning now to this broader system view, FIG. 5 outlines a useful method that can be accomplished by some systems that implement the inventive principles.

To begin, a PTR device is initialized with operating parameters appropriate for the mission (510). For example, a child-safety tracker might be programmed with a geographical boundary encompassing the child's home, school, and commute route; and a velocity envelope from 0 to 35 m.p.h. (56 km/hr), while a shipment-tracking device might have temperature, humidity and acceleration (shock) ranges or limits set. This configuration step may be performed once when the system is provisioned, or repeated occasionally as the PTR is deployed to support various tasks. Once configured, the PTR is dispatched with the person or object to be tracked and monitored (520), where it begins to operate autonomously, providing reports according to the budgeting process described above (530).

Data reports are received and aggregated by another participant in the system (540) (for example, the web server shown as 240 in FIG. 2). Reports may be time-stamped and replayed for a viewer on demand or analyzed to obtain other information about the journey of the tracked person or object.

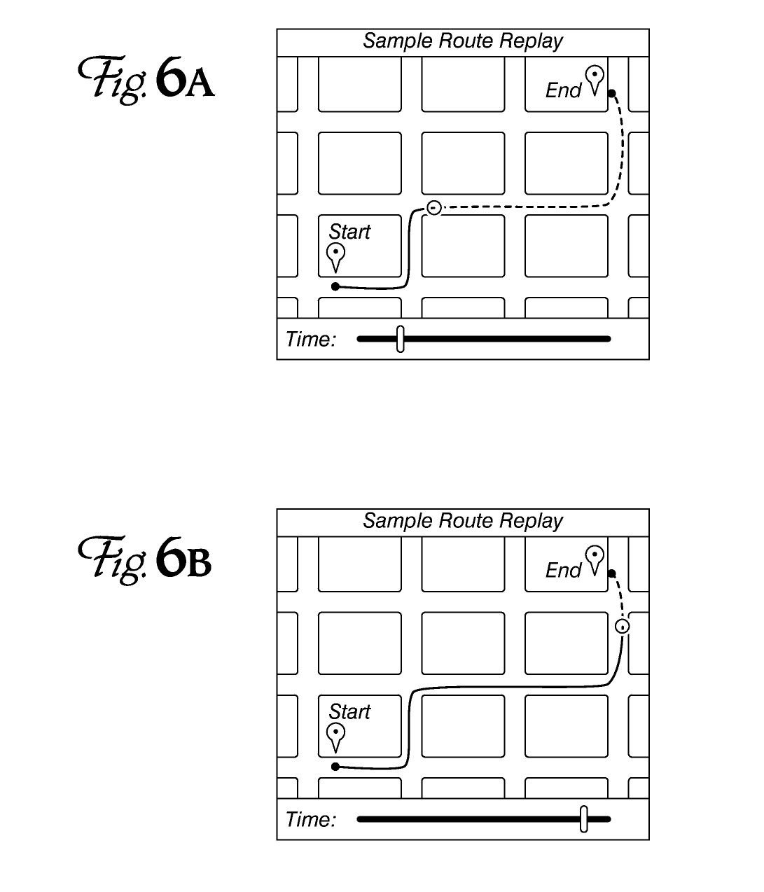

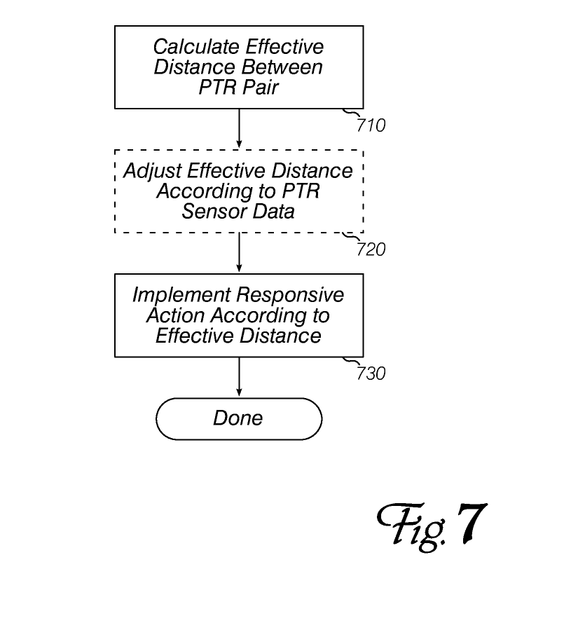

In one embodiment, a web browser displays an augmented map with a time-marked slider. As the user operates the slider, the map shows the location and other sensed conditions reported by the PTR (see FIGS. 6A and 6B, showing a sample web browser display). This interface can be extended to show multiple tracks recorded at different times by the same (or a different) PTR. For example, tracks recorded on different days can be replayed simultaneously to show variations in routes traveled, differences in speed (e.g., due to different traffic conditions), or differences in conditions encountered. In one embodiment, tracks recorded from competitors in a race can be overlaid and played simultaneously to show where one competitor is slower or faster than his peers. In this embodiment, other data may also be illuminating: for example, in an auto race, throttle and brake position, engine performance and G forces experienced may help identify differences between vehicles.

As explained earlier, the PTR may change its report rate automatically if it experiences an emergency (here defined as a location or condition that falls outside acceptable ranges configured during provisioning) (550). A user at a remote location from the PTR may also trigger an altered reporting rate based on reports from the PTR or on information received from another source (560). The system may use any communication method supported by the PTR hardware to deliver a message to cause the report rate change. For example, in a system where the PTR comprises a GSM communication module, a message to the PTR may carry the command to change reporting rate, operating envelope parameters, or other settings. A security filter may reject commands that do not come from a predetermined telephone number, or that lack a predetermined password or other authentication key. The change may be accomplished by adjusting a parameter of the reporting-budget process.

In some embodiments, the system may provide new or different “acceptable envelope” parameters to the PTR through the communication channel. For example, a child-tracking application may provide a parent with the ability to change the boundaries of the expected geographic range so that the child can participate in a field trip without triggering a “child abducted” exigent circumstance. Or the report value can be adjusted on an ad-hoc basis to reduce the report rate and save battery power if a shipment tracked by the PTR is expected to be delayed for a time at a warehouse.

In some embodiments, a programmatic interface may be provided to permit automatic processes (rather than human operators) to examine data from the PTR or to change the PTR's functional parameters.

Following is a non-exclusive list of conditions that may be detected or acted upon by a PTR according to an embodiment of the invention:
PTR exceeds a threshold altitude
PTR exceeds a threshold velocity
PTR experiences an altitude change exceeding a threshold
PTR enters a bounded geographic area
PTR leaves a bounded geographic area
PTR has not made a successful report for longer than a threshold time
PTR has moved more than a threshold distance since the last successful report
PTR receives data from an external sensor that is outside a configured acceptable range
PTR communicates with medical sensors for reading the health information of a subject (e.g., heart rate, respiration, temperature, blood sugar) and recognizes that the reading is outside a configured acceptable range
PTR loses communication with an external sensor
PTR actuator (e.g., button) is operated
PTR establishes a connection with a wireless network
PTR detects a low-battery condition
PTR detects a loud noise such as a scream from a child

A server computer that receives location and environmental (or other sensor) data from a PTR may itself detect certain events or conditions and take action in consequence. For example, the server may be configured with an independent set of locations or conditions, and may take certain actions if a report from the PTR shows that one of the server-configured limits or thresholds has been violated. The server may, without limitation:
Transmit an alert to an interested party via email, SMS, or voice mail
Broadcast an alert to a group of recipients
Send a message to another PTR device to potentially put this in a new state.

In some embodiments, a portion of the system logic may reside and execute at a computer in the possession of an end user. For example, an application on a “smartphone” may be provided to query the server occasionally for recent information reported by the PTR. Such an application may have its own set of locations or conditions against which the PTR reports are compared.

Some embodiments of the invention are based on interactions between components of a system like that of FIG. 2, but with two or more PTR devices reporting location and other data. The additional PTRs, like PTR 210, may report their information through a gateway like 220, or directly to other computers participating in the embodiment. PTRs may report to different servers or to the same server. If the PTRs report to different servers, then some of those servers must forward some of their PTR-provided data to another computer in the system so that the latter computer can perform operations based on data from the two or more PTRs.

The computer which has data from multiple PTRs may perform a method similar to that outlined in FIG. 7. First, the effective distance between a pair of PTRs is calculated (710). Next, other sensor data from one or both PTRs may be used to adjust the effective distance (720). Finally, a responsive action is taken based on the (possibly adjusted) effective distance (730).

The effective distance may simply be the linear distance between the PTRs in the pair. However, in many cases, it is useful to compute the effective distance as a function of features of the environment around and between the PTRs, as a function of the recent history of the PTRs, or both. For example, in an urban environment, two pairs of PTRs that are the same linear distance apart may be treated as existing at different effective distances. A pair of PTRs that are 2 km apart, but both on the same major thoroughfare, may be at a shorter effective distance than a pair of PTRs that are also 2 km apart, but at different points in a downtown street grid environment with many one-way streets between them. The effective distance from one PTR to the other may even be different from the distance from the second PTR to the first. For example, if both PTRs are being carried along the same one-way street, the following one may be “close” to the leading one, whereas the leading one may have to travel a long and circuitous route to return to the location of the following one. Similarly, historical velocity data of each PTR; available travel routes; and expected, historical or real-time traffic data can be incorporated into the effective distance calculation to account for the ease or difficulty of one PTR traveling to the location of the other. In these situations, the computer refers to auxiliary travel-restriction data, apart from the data reported by the PTRs, to determine an appropriate adjustment to the effective distance.

Other PTR-reported data may also affect the effective distance calculation. For example, altimeter data may show that one PTR is airborne, or accelerometer data may suggest that the PTRs are traveling by different means of transport. An airborne PTR may be considered to be at a significantly increased effective distance from a PTR in a land vehicle.

Once the effective distance is calculated, actions similar to those of other embodiments may be taken based on the distance. For example, one or the other PTR's reporting rate (or both rates) may be adjusted. A message may be sent to a different device, such as a client computer or cell phone. Or the system may direct one or both PTRs to activate an indicator such as a sound, vibrator or light.

Multi-PTR embodiments with the capabilities described above can be used in a number of practical applications, including:
Threat Tracking
The subject of a restraining order may carry a first PTR, and the system can notify the holder of a second PTR if the effective distance between the first PTR and the second PTR falls below a configurable threshold.
Child Safety
A convicted sex offender may be required to carry a PTR, whose reports can be monitored for effective proximity to a PTR carried by a child. Insufficient distance may cause increased reporting rates and/or notification messages to be sent to a third party (e.g., a parent) via computer or cell phone. An audio monitor in a child's PTR may detect shouts or screams and adjust tracking rates accordingly. Furthermore, an audio monitor (e.g., a microphone) can be used to record brief audio samples, which may be transmitted along with other data reported by the PTR. An external trigger (e.g., a text message from an authorized user) or an internal trigger (e.g., insufficient distance from a threat) may also cause recording and reporting of audio samples.
Wilderness Tracking
Companions traveling outdoors (skiers, hikers, boaters) may carry PTRs, and may receive notifications if one of their group falls behind or becomes separated. In outdoor sports such as cycling or marathon running, competitor vital signs may also be monitored and reported to compare relative levels of exertion. Sound-level meters in a PTR may be able to detect a starting-gun sound and increase report rate to provide better tracking during an event.

An embodiment of the invention may be a machine-readable medium having stored thereon data and instructions to cause a programmable processor to perform operations as described above. In other embodiments, the operations might be performed by specific hardware components that contain hardwired logic. Those operations might alternatively be performed by any combination of programmed computer components and custom hardware components.

Instructions for a programmable processor may be stored in a form that is directly executable by the processor (“object” or “executable” form), or the instructions may be stored in a human-readable text form called “source code” that can be automatically processed by a development tool commonly known as a “compiler” to produce executable code. Instructions may also be specified as a difference or “delta” from a predetermined version of a basic source code. The delta (also called a “patch”) can be used to prepare instructions to implement an embodiment of the invention, starting with a commonly-available source code package that does not contain an embodiment.

In some embodiments, the instructions for a programmable processor may be treated as data and used to modulate a carrier signal, which can subsequently be sent to a remote receiver, where the signal is demodulated to recover the instructions, and the instructions are executed to implement the methods of an embodiment at the remote receiver. In the vernacular, such modulation and transmission are known as “serving” the instructions, while receiving and demodulating are often called “downloading.” In other words, one embodiment “serves” (i.e., encodes and sends) the instructions of an embodiment to a client, often over a distributed data network like the Internet. The instructions thus transmitted can be saved on a hard disk or other data storage device at the receiver to create another embodiment of the invention, meeting the description of a machine-readable medium storing data and instructions to perform some of the operations discussed above. Compiling (if necessary) and executing such an embodiment at the receiver may result in the receiver performing operations according to a third embodiment.

In the preceding description, numerous details were set forth. It will be apparent, however, to one skilled in the art, that the present invention may be practiced without some of these specific details. In some instances, well-known structures and devices are shown in block diagram form, rather than in detail, in order to avoid obscuring the present invention.

Some portions of the detailed descriptions may have been presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the preceding discussion, it is appreciated that throughout the description, discussions utilizing terms such as “processing” or “computing” or “calculating” or “determining” or “displaying” or the like, refer to the action and processes of a computer system or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, including without limitation any type of disk including floppy disks, optical disks, compact disc read-only memory (“CD-ROM”), and magnetic-optical disks, read-only memories (ROMs), random access memories (RAMs), erasable, programmable read-only memories (“EPROMs”), electrically-erasable read-only memories (“EEPROMs”), magnetic or optical cards, or any type of media suitable for storing computer instructions.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will be recited in the claims below. In addition, the present invention is not described with reference to any particular programming language. It will be appreciated that a variety of programming languages may be used to implement the teachings of the invention as described herein.

The applications of the present invention have been described largely by reference to specific examples and in terms of particular allocations of functionality to certain hardware and/or software components. However, those of skill in the art will recognize that a position- and condition-tracking sensor command & control network can also be produced by software and hardware that distribute the functions of embodiments of this invention differently than herein described. Such variations and implementations are understood to be captured according to the following claims.

We claim:

1. A system comprising:
a Position Tracking and Reporting (“PTR”) device having geographic location determination, environmental condition sensing and data communication capabilities; and
a server computer having a first communication interface to exchange data with the PTR device and a second communication interface to exchange data with a client computer via the Internet, wherein
the PTR device is to be configured with a first operating envelope at a commencement of a mission;
the PTR device is to autonomously report its location and environmental condition to the server computer at a first rate before a trigger event; and
the PTR device is to autonomously report its location and environmental condition to the server computer at a second, different rate after the trigger event.

2. The system of claim 1 wherein the trigger event is detected by the PTR based on the first operating envelope and a geographic location determined by the PTR.

3. The system of claim 1 wherein the trigger event is detected by the PTR based on the first operating envelope and an environmental condition sensed by the PTR.

4. The system of claim 1 wherein the trigger is transmitted from the client computer to the server computer via the Internet.

5. The system of claim 1 wherein the server computer comprises a web server to transmit location and environmental condition data from the PTR to the client computer.

6. The system of claim 1 wherein the client computer is a mobile telecommunications device having a programmable processor, the client computer further including instructions to cause the programmable processor to perform operations comprising:
querying the server computer for recently-reported data from the PTR device; and
notifying a user of the client computer if the recently-reported data falls outside an acceptable envelope specified at the client computer.

7. The system of claim 1 wherein the geographic location determination capability of the PTR device is a Global Position System (“GPS”) receiver.

8. The system of claim 1 wherein the environmental condition sensing capability of the PTR device is one of an altimeter, a hygrometer, a thermometer, a sound level meter, or an accelerometer.

9. The system of claim 1 wherein the environmental condition sensing capability of the PTR device is to detect a health indicator of a person carrying the PTR device.

10. The system of claim 9 wherein the health indicator is one of a heart rate, a respiration rate, a body temperature or a blood sugar measure.

11. The system of claim 1 wherein the PTR device is to vary its report rate according to a budgeting algorithm that considers a value of a report and a cost of transmitting the report.

12. The system of claim 1 wherein the data communication capabilities of the PTR device is a GSM transceiver.

13. The system of claim 1 wherein the data communication capabilities of the PTR device is an 802.11 wireless network adapter.

14. A computer-readable medium containing instructions to cause a programmable processor to perform operations comprising:
receiving a first report from a first Position Tracking and Reporting (“PTR”) device and a second report from a second PTR device;
computing an effective distance between the first PTR and the second PTR based on data contained in the reports; and
transmitting a message to a remote computing device if the effective distance is less than a minimum distance or if the effective distance is greater than a maximum distance.

15. The computer-readable medium of claim 14 wherein computing the effective distance is computing a linear distance between the first PTR and the second PTR.

16. The computer-readable medium of claim 14, containing additional instructions to cause the programmable processor to perform operations comprising:
adjusting the effective distance according to an environmental condition reported by one of the PTRs.

17. The computer-readable medium of claim 14, containing additional instructions to cause the programmable processor to perform operations comprising:
adjusting the effective distance according to a travel-restriction condition available to the programmable processor independently of the first report and the second report.

18. A position tracking and reporting (“PTR”) device comprising:
locating means for determining a geographic location of the PTR;
sensing means for detecting an environmental condition at the PTR;
communicating means for transmitting data from the PTR to a remote computer;
alerting means for notifying a person near the PTR of an event;
a memory for storing data and instructions; and
a programmable processor for causing the locating, sensing, communicating and alerting means to operate in accordance with the instructions and data in the memory, wherein
the instructions and data are to cause the PTR to activate the alerting means when data are transmitted by the communicating means.

19. The PTR of claim 18 wherein the sensing means is to take a blood-glucose reading of the person, and the memory contains instructions and data to cause the programmable processor to activate the alerting means if the person fails to activate the sensing means at a scheduled time.

20. The PTR of claim 18 wherein the memory contains instructions and data to cause the programmable processor to store information comprising a geographic location and an environmental reading until the communicating means is able to transmit the information to the remote computer.

21. The PTR of claim 18 wherein the sensing means is to detect an audible sound at the PTR and the communicating means is to transmit data representing the audible sound.

22. The PTR of claim 18 wherein the alerting means is one of a vibrator or an audible-tone generator.

23. The PTR of claim 18 wherein the sensing means is to capture a visual image of the environment near the PTR and the communicating means is to transmit data representing the visual image.

24. The PTR of claim 18 wherein the sensing means is to capture audible sound at the PTR and the memory contains instructions and data to cause the PTR to recognize a voice command in the audible sound.

25. The PTR of claim 18 wherein the sensor is to detect a radar signal from a passing car, the PTR further comprising:
a camera to capture an image of the passing car, wherein
the memory contains data and instructions to cause the PTR to transmit the image of the passing car to the remote server.
